(19) United States
(12) Patent Application Publication
(10) Pub. No.: US 2021/0174275 A1
(43) Pub. Date: Jun. 10, 2021

(54) SYSTEM AND METHOD FOR THE DESIGN INDUSTRY THAT ENABLES CREATIVE TEAMS TO DESIGN, COLLABORATE AND CONNECT WITH CLIENTS AND TRACK AND MANAGE PROGRESS OF EACH CLIENT PROJECT PROVIDING CLIENT STATUS TO ALL INTERESTED PARTIES

(71) Applicant: ERINN VALENCICH, BEVERLY HILLS, CA (US)

(72) Inventor: ERINN VALENCICH, BEVERLY HILLS, CA (US)

(21) Appl. No.: 17/096,862

(22) Filed: Nov. 12, 2020

Related U.S. Application Data
(60) Provisional application No. 62/934,990, filed on Nov. 13, 2019.
(60) Provisional application No. 63/036,891, filed on Jun. 9, 2020.

(51) Int. Cl. G06Q 10/06; G06F 30/20

(52) U.S. Cl. CPC G06Q 10/0633; G06F 2111/02; G06F 30/20; G06Q 10/0631

(57) ABSTRACT

The present invention is an operating system for the design industry that provides a more efficient process of collaborating and buying products, whereby all aspects of workflow management are incorporated into one streamlined platform, including presenting visual concepts and aggregating design ideas, project budgeting, invoicing, inventory and project management with client reporting. The present invention allows design professionals greater access to merchandise and sales to end clients. Designers can incorporate merchandise from a marketplace using drag-and-drop functionality right into their client presentations and features a digital product library that lets creative teams upload images from various online sources and share these same products and projects with their clients. Designers can also use the same platform according to this invention to be able to track client feedback and utilize artificial intelligence and EDI interfaces (and transportation tracking information and real time GPS locations) to increase client satisfaction.

### PRIORITY CLAIMS

This application claims the benefit of U.S. Provisional Patent Application Ser. No. 62/934,990 filed on Nov. 13, 2019, and U.S. Provisional Patent Application Ser. No. 63/036,891, filed on Jun. 9, 2020, the contents of which are incorporated herein by reference.

### BACKGROUND OF THE INVENTION

The face of the design industry is changing, as a new guard of millennial design professionals are demanding a digital-first solution to run their workflows, from client communication to product purchasing. The $664 billion global design industry runs on archaic technology & processes, and the luxury sector alone is transacting $30 billion a year predominantly offline via mailing checks and faxing back forms and mailing or express mailing color samples, fabric samples and wallpaper samples, not to mention magazine or press clippings.

It is estimated that approximately 20% of the design industry is based on creative and business development, while 80% is based on administrative processes such as: quoting; order processing and tracking; phone calls; and logistics. There is no e-commerce in luxury furnishings and building materials that means major opportunity to unlock this space.

The established model of the design industry is based on physical spaces known as design centers. These brick and mortar design centers are currently only found in major cities. In the design center, manufacturers must pay by the square foot for retail space. The showroom owner controls the visibility of manufacturers, and also regulates the products shown by these manufacturers.

At the center of the design industry is the Design Professionals, consisting of Senior Designers, Architects and Designer Assistants. The design professional is responsible for communicating with clients, contractors, subcontractors, and showrooms that are selling products. The average project requires approximately 300 items to source, coordinate, purchase and track. Transactions are done by phone, fax and mail, while project management is done through email and spreadsheet software.

The current workflow options used by the design industry begin at curating and collecting design inspiration. This is typically done using online aggregation platforms such as Pinterest (to store pictures of rooms, etc.) to get cohesive visual concepts for a new project. This inspiration is then shared with the team and client. Usually, designers tend to abandon their aggregated collections of design inspiration on these platforms as these collections don't connect or serve any additional purpose.

The next phase of the design process is the creative process, sourcing and budgeting. The scope of work and budget are typically done using software such as Excel or an online platform such as Google Docs. This can also be done in software such as Studio Designer & Ivy, but the process is incredibly slow, and requires too much time to add every item one by one, assign a vendor and save it. This is especially problematic early on in the design process when the designer does not know the vendor or when the client may never purchase a particular item, which is a critical opportunity cost.

When a designer is sourcing products to sell, the designer searches approximately 50 to 80 websites to hunt through entire catalogs to source products for their projects. All are password protected and sharing links with team members is not an option. Taking screenshots of these products to create visuals and then tracking where those items came from in Excel is the normal process, but this proves to be very time consuming and frustrating.

The visual aspects of a design project created in software such as PowerPoint, Keynote or InDesign, and then shared with the design team and the client in Portable Document Format (PDF) format. The client doesn't know from this PDF what the design correlates with on the budget, unless complex tagging system is included. This creates client frustration as the PDF visuals and budget don't connect and have to be manually updated on both sides. Most designers abandon visuals after this as it's too much work to maintain, yet you still need to provide visuals for client reference.

The final phase of the design process involves invoicing and project management. Once the budget and design have been approved by the client, the designer has to put that information into a platform to generate an invoice. Designers tend to use Excel for this task, but QuickBooks, Ivy and Studio Designer are also commonly used invoicing platforms. Most designers must manually enter an average of 300 items per project into the invoicing platform. It can take weeks to get all the correct quotes needed phone, email, etc., for each item. Then, the designer must input all the details one by one into the software. This is an inefficient process where mistakes can easily be made, causing confusion for the client.

Project management is typically also done using Excel, Ivy, Studio Designer, or Basecamp. The problem is that all of this software requires manual entry. There is no automation and no connection to other phases of the design project. The designer is not able to set alerts or reminders or collaborate with the rest of the design team. The status of a project is not easily visible. The designer must hunt down each item individually or run a very complex report. The main issues in this phase are the complexities of manual entry and the repetitive work.

It is evident that current workflow software used by designers is fragmented and frustrating, resulting in inefficiency and countless hours of lost time, user error and dissatisfied clients. A designer must use multiple workflow platforms for one project, for example, a designer has to use separate platforms to: aggregate and save concepts and ideas; put together visual presentations for clients; budget; create invoices; and manage the project. This can result in disorganization and multiple mistakes.

The current online platforms that aim to address the designer's needs prove to be limited in terms of how they actually benefit the designer. Currently, the product marketplaces available for designers to search and buy products online include 1stDibs and Eporta. 1stDibs is the current leader in online antiques and vintage products, and big ticket items, proving that people will shop for furniture sight-unseen. Every day, at least 20 items over $10,000 are being sold on their platform. They are widely searched by designers but a very punitive business for brands, dealers, and sellers to participate in, as they tend to charge huge monthly fees, listing fees and commission. Many showroom owners have mandated that if a brand does go on 1stDibs, that brand will be dropped because the model was made for consumers, not business to business (B2B) sales. Since 1stDibs have not brought the showrooms online to begin with, the big brands will not use this platform. They also offer no options in terms of project management.

Eporta is an online marketplace that has aggregated some products, mostly in the Scandinavian/modern aesthetic, and mostly from brands that already have their own e-commerce platforms. Eporta requires the designer to get approved for an account for each brand before accessing product pricing. It is limiting in its global scope and aesthetic offering. Additionally, any product that is made to order cannot be sold via Eporta, so it functions mainly as a designer look book and sales tend to happen “offline.” Eporta charges more for products on their platform than if a designer buys direct, which tends to discourage any big brands from offering products on this platform.

The main online platforms that provide accounting and back office services to designers are Ivy and Studio Designer. Ivy was not developed by designers, and sold to Houzz, upsetting and alienating big design brands that did not want to have any association with this company. Despite having a clean and simple interface, all data entry is completely manual, and not as powerful for accounting tasks. Ivy is limiting as it cannot handle any projects with budgets of over a million dollars, so it is not useful to big design brands.

Studio Designer is currently the most widely used invoicing software for designers, however the platform is outdated and has low market adoption, as it's very complex and hard to use. It requires hours of training and experience with accounting to run it. Studio Designer functions similar to QuickBooks, and is not able to monetize purchasing. They have tried to integrate a ‘vendor portal’ that lacks any sort of functionality. Their customer base is primarily individual designers, not larger design firms.

When it comes to online platforms for order management for showrooms and brands and back office platforms for furniture makers and sellers, there is no viable solution currently available. Technology in this space is just as fragmented and outdated. Several different platforms have to be used to make a sale and track the shipment. Some big firms keep track of manual entry errors that create losses each month because of mistakes being made in the order entry process. Customer Relationship Management (CRM) or Enterprise Resource Planning (ERP) Platforms such as SalesForce and Odoo can be used but require lengthy and complex customization processes and costly initial build to get started, and still fail to meet the specific needs of furnishings manufacturers, brands and showrooms, such as lacking the ability to split a purchase order or facilitate the communication touch points that the design industry requires.

In the field of interior design in particular, there has existed historically the reliance upon handwritten notes and physical materials such as torn off magazine pages which depict desired design articles or aspects, fabric samples, wall paper samples, paint samples, photographs, and various accessories for color, texture and style matching. At times, various interior designers like to “hold onto” these notes as a way to prevent client migration or price shopping.

Artificial Intelligence (AI) is rapidly becoming an essential business management and e-commerce tool, giving organizations valuable insights into their data and doing so with unprecedented velocity and accuracy. AI facilitates breakthrough innovation in a variety of fields while delivering significant acceleration in time to insight. Tremendous resources are being invested by enterprises, universities and government organizations to further develop and benefit from AI and Deep Learning (DL).

AI applications are built upon artificial neural networks (ANNs) trained to extract valuable information from the massive datasets presented to them. A specialized AI software framework will typically scan millions of parameters and billions or trillions of samples, to rapidly define and connect separate layers of nodes together, thereby establishing a data flow which yields valuable conclusions and powerful results.

The IT infrastructure supporting an AI-enabled datacenter must adapt and scale rapidly, efficiently and reliably, as data volumes grow and application workloads become more intense, complex and diverse. It must seamlessly and continuously handle transitions between different phases of experimental training and production inference in order to provide more accurate answers, faster. The IT infrastructure is key to realizing the full potential of AI in e-commerce.

Current enterprise datacenter IT infrastructures are woefully inadequate in handling the demanding needs of AI and DL. Designed to handle modest workloads, minimal scalability, limited performance needs and small data volumes, these platforms are highly bottlenecked and lack the fundamental capabilities needed for AI-enabled deployments.

### SUMMARY OF THE INVENTION

The present invention is a Software as a Service (SAAS) platform for the design industry that provides a more efficient process of collaborating and buying products, whereby all aspects of workflow management and associated software are incorporated into one streamlined platform, including but not limited to: presenting visual concepts and aggregating design ideas; project budgeting; invoicing; and project management.

The present invention allows design professionals greater access to merchandise selection and optimization to enhance sales and end client satisfaction. According to some embodiments, designers can incorporate merchandise from a marketplace using drag-and-drop functionality right into their actual client presentations. The present invention features a digital product library that lets creative teams upload pictures and images from various online sources and share these same products and projects with their clients. Designers can also use the same platform to and are able to track client feedback, including managing the selection of design articles as a function of an overall budget established between the designer and end client.

The present invention serves as an imaging search and optimization engine for interior design. The platform of the present invention implements uploaded images of products such as furniture and home goods together with Artificial Intelligence (AI) for visualization, designer reference, and to help vendors and designers determine what products can sell optimally and where they can be implemented for the customer or client. This imaging data is collected and stored on the platform of the present invention and can be provided to both the vendor and designer to aid with sales and client design projects. Vendors can use this data to forecast future sales and optimize the current available products, such as how the products are being implemented by customers. Designers can use this data to optimize the interior design process for the client.

Various homeowners and designers work together at various levels. Often, designers are associated with larger firms or even product brands or homebuilder groups. For example, large multi-national home builders including luxury homebuilders often offer design services. According to the present invention, homeowners or home tenants may now project what their existing furniture will look like in a home intended for occupancy, or, what furnishings not yet purchased will look like in a home under consideration for occupancy. In this manner, homeowners or occupants may for the first time optimize what size and design of home will be desirable in view of the desired furnishings within a home, taking into account all costs, sizes, lead times and style, uniqueness and availability of accessories. AI is utilized to facilitate this process, as to date, it has been left to designers to manually visualize this optimization process, taking into account a virtually endless number of design criteria.

What is of paramount importance according to the present invention is the imaging of interior spaces that already exist, the design of spaces not yet constructed, versus the furnishings already owned or readily available, furnishings to be acquired or designed from scratch, including all the variables associated therewith, including price, lead times, options, dimensions available, finishes, and so forth.

In addition, according to the present invention, all constituencies are kept “on the same page”, so that the designers, end customers, manufacturers, and all the trades (installers, shippers, 3PLs, etc.) can track all design elements from inception, through creation and execution, shipping and delivery through installation, so that all design elements may be visualized in real time.

In one embodiment, the imaging engine of the present invention can be implemented to show the work in progress for the design project and the progress of the delivery of an order. Imaging can be used as a means of scanning the product to confirm delivery, as well as providing continuous updates on the status of a product installation or a design project that is in progress. Designers can provide clients with real time updated imaging data to improve client communication and streamline the interior design process.

In another embodiment, the imaging engine of the present invention can be used in partnership with home builders in model homes to showcase products for vendors and also serve as portfolios or inspiration to designers. Model homes can use image visualization to show products used in the context of the home. The imaging engine can close the gap and improve on the cohesion between the designer, the manufacturer or vendor, and suppliers. The client is able to view potential furniture purchases in 3D metadata in a virtual reality space. AI and image recognition are incorporated when the client is browsing products in a showroom and products are auto-categorized based on parameters such as product type. Marketplace products can be connected directly with designer projects and designer product libraries.

In another embodiment, the present invention incorporates a bulk upload feature on the online platform and mobile application for product images and relevant product information. The bulk upload feature is AI enabled for faster image recognition and product sorting and categorization in the product image library. Image categorization and tagging is used to supplement the present invention's AI engine in order to further understand and refine product subcategories, product tags, and brands.

Various embodiments of the disclosed technology start in the beginning of the design process, from inspiration through product purchasing. Products can be sourced through the digital product library, which allows design teams to save products they love in a central database to shop repeatedly. From the product library, designers can click into the product's detail page and get pricing, finish options, and chat with the product sales representative, resulting in a seamless purchasing integration. Designers can collaborate with their design team and clients from the projects function, tracking all communication and approvals so it's easy to reference certain products later in the design process, resulting in major time savings.

The present invention is a workflow software system that integrates several previously fragmented software platforms into one integrated solution. One platform is a CRM SAAS for design teams, allowing seamless integration between the design team and the clients, contractors, subcontractors and product showrooms. This platform mirrors the workflow from the initial design, to sales, manufacturing, ordering and installation. The second platform integrated into the present invention is the B2B Marketplace e-commerce portal, allowing for all parties in the design process to share the same product and order data and view the order status of all products in real time. This results in less redundancy, fewer manual entry errors and faster communication.

The present invention incorporates various embodiments into one streamlined workflow. Designers can upload all images of design inspiration to the digital product library and assign these specific images from the library to certain projects. Clients and other design team members can provide feedback by rating, approving or rejecting the images, and leave comments. The whole team can see what was liked or disliked about a certain image.

According to some embodiments, the design budget can easily be drafted in the platform budgeting module, and then shared with the client for review and approval. The budget can auto-update, allowing designers to quickly change an item and give updates throughout the design process once the invoicing stage has started. All members of the design team can also use this budget to shop for approved products. Click on each product within the budget links the designer directly to the digital product library or marketplace where that exact product can be purchased. In other embodiments of the invention, system integration is necessary with various EDI (Electronic data interchange) providers and associated ERP (Enterprise resource planning) resources so that the present invention may provide a frictionless data gateway between various good and services providers, including 3PL (Third-party logistics) involved in supply chain management. It is generally well-known in the art how various communications protocols may be oriented to obtain optimal results. While conventional network interfaces are largely anticipated, as an alternative, peer to peer or Blockchain orientations are just as available as a matter of design choice.

According to some embodiments, the designer can create visual presentations and project boards from the digital product library, with the ability to save, reuse and expand on previously created visual presentations and boards. This saves the designer time through the use of previously built design templates. Designers can shop from their budget in linked online showrooms to quickly source all items in the visual presentation. There is no need to copy, paste and keep track of product links in emails to other design team members and clients. Designers can use a virtual clipper tool to pull items from around the web and integrate them into the visual presentation. This function can also allow designers to shop through all images that have already been uploaded to the digital product library.

According to some embodiments, the designer can also create instant invoices using online marketplace items that are linked to product data. This results in significant time savings as the designer can click to buy online and no longer has to call each showroom directly for quotes. Invoices from one project can easily be used in other projects. Product images are linked in the invoice so clients can easily follow the project budget. Budget reports can be quickly generated and shared for design team and client review based on workflow.

According to some embodiments, the workflow software features automated project management tools, such as shared portals from showrooms and product brands and manufacturers, to manage product orders. Product information can be updated on one end and visible to all parties in real time. Designers can also set alerts, for example, when there are any changes to specific products, payment due dates and shipping status updates. This allows for easier management of large-scale projects where hundreds of items are required.

In accordance with the preferred embodiment of the present invention, the designer project management portal allows the designer to set dates pertaining to product purchasing and project deadlines. The project management workflow software tracks all aspects of the product delivery for the designer.

According to some embodiments, the present invention operates on a cloud-based system, and users of the platform can be separated by geographic locations as well as by user groups. The workflow platform operates on a hierarchy of users that can be separated into several groups: the designer; the client; product manufacturer or retailer; builders; architects; sub-contractors and workrooms; and, shipping and receiving. All user groups can control the workflow of a project, resulting in increased efficiency and work product. Notably, key stakeholders may each have access to the system according to the present invention so that clients, internal design teams, vendors or suppliers, 3PL interests or shippers and installers in the field are all synchronously informed and polled to make certain that client expectations are met and that all status reports of ongoing activity are updated in real-time or period as desired. Importantly, the present invention may be modified to include any number of key stake holders.

According to some embodiments, the workflow software allows designers to share a design project with a client and allow the client to access the marketplace so that client can browse through a greater variety of products. The client can add more items from the online marketplace to the project to be reviewed by the designer. However, the client cannot initiate the purchase of any product within the online marketplace, this is done by designer. An end user can sign up for the online platform to upload a project without marketplace access. This software mimics the current design industry model of the relationship between the designer and the manufacturers at physical design centers and showrooms, as the designer is the primary purchaser of goods.

According to some embodiments, the workflow software allows the designer to be able to view client login data and activity data within the designer portal. This gives the designer better management capabilities of clients and client projects and allows the designer to steer the client and influence them towards certain items based on designers being able to see what client has been browsing in marketplace. This enables the designer to manage client interest and expectations to achieve the best possible results. These capabilities also allow for improved management of the project budget. The designer and creative vision can be protected through watermarking functions. When a designer shows visual presentations or suggests products to the client, the designer is able to watermark all presented work such as images and presentations, to prevent the client from using the designer's work without the designer's knowledge or permission. This watermarking function can be incorporated through pixel modulation of the shared files or embedded serial number technology.

According to some embodiments, the workflow software parameters are not limited or governed primarily by the actual project budget as it was initially outlined to the client. An initial budget is generated but does not limit the browsing and purchasing actions for both the client and the designer within the online marketplace. The designer has the overall influence on the design aspects and preferences for each project. The designer leads the client based on creativity and optimal design.

According to some embodiments, the present invention can host an unlimited amount of virtual design centers, while at the same time enabling design centers to make better use of the current physical design center model because this platform creates more retail options. Brands can create online virtual showrooms, and these showrooms can be controlled and augmented by the software administrator to allow for efficient flow of products and information to the designer. The present invention expands the reach of physical design centers through virtual spaces, supplementing and potentially revolutionizing the current physical design center model.

According to some embodiments, the present invention can incorporate Artificial Intelligence (AI) elements to provide aggregated knowledge-based feedback to the user. For example, certain products may be made out of a specific material that can be affected by climate conditions or not suitable for a certain room type such as a bathroom. Through the use of AI and aggregated user experience, the user can be notified regarding a specific product before implementing that product into the overall project. Natural Language Processing can help facilitate communications between the platform and users by analyzing unstructured text and extract data to recommend responses to clients and vendors including showrooms and manufacturers. Through the same AI elements, a knowledge base or data storage with historical data is created as part of the platform that can store other influential factors such as designer aesthetics and preferences. In addition, the platform will be able to recommend potential products based off of user inputted two or three dimensional room elements and project level data. For example, the user can upload a computer aided design (CAD) file to the platform which can identify room dimensions and recommend specific brands and products that correspond to the items or products identified as needed for the project, optimized for lead times, delivery schedules, and budget parameters set in the system. This knowledge can be used to recommend or curate similar products for the designer over time. The system can be the “smartest sales rep a brand could have” as it can pull from all the answers that usually one human shares with one human and then be able to provide those answers to anyone in the future. As AI or machine learning code is developed, adaptation to the present invention is widely anticipated.

The revenue model of the present invention can change and adapt over time. According to some embodiments, the current revenue model of the present invention is subscription based. This will prevent certain manufacturers to become advertising sponsors from purchasing advertisements on the platform that can distort marketplace results and workflow for designers. Designers are able to monetize the platform through project-based commissions.

A primary purpose of the present invention is to use imaging and associated data collection to build a database which enables interior designers and their clients to minimize the need for paper handwritten notes and promote the ability to imagine fabrics and wall papers, etc., so that all involved in the design process are kept up to date as to the progress of each project.

The present invention can be accessed across multiple platforms, including mobile smartphone devices, mobile tablet devices and wearable technology such as a smart watch that syncs with a mobile smartphone device or interactive glasses that allow the user to store data on an external server. A smart watch or smartphone can function as a geolocation and tracking device for the user. Interactive glasses function as a means of checking in to a location and collecting photographic data of the event. Interactive glasses or smartphone can be later used to present design to user using augmented reality.

These and other aspects, objects, features and advantages of the present invention, are specifically set forth in, or will become apparent from, the following detailed description of an exemplary embodiment of the invention.

### BRIEF DESCRIPTION OF THE DRAWINGS

FIG. 1 is a diagram of user flow through the platform of the present invention.

FIG. 2 is a diagram that shows different modules of the platform which are available directly or indirectly through Application Programming Interface (API).

FIG. 3 is a diagram of the platform architecture of the present invention.

FIG. 4 is an overview of the services of the present invention.

FIG. 5 is an overview of various user services of the present invention.

FIG. 6 is a diagram of the platform of the present invention in relation to other current platforms and services.

FIG. 7 is a screenshot of the platform of the present invention relating to the digital library storage as to available products or design elements.

FIG. 8 is a screenshot of the platform of the present invention depicting a design firm's product library or inventory.

FIG. 9 is a screenshot of the platform of the present invention depicting detailed information about a product.

FIG. 10 is a screenshot of the platform of the present invention depicting an online retailer collection of product offerings available to users of the platform according to the invention.

FIG. 11 is a screenshot of the platform of the present invention wherein various client orders are being tracked according to the present invention.

FIG. 12 is a screenshot of the platform of the present invention wherein various client payments are being tracked according to the present invention.

FIG. 13 is a screenshot of the platform of the present invention wherein an entire client project progress is being tracked according to the present invention.

FIG. 14 is a screenshot of the platform of the present invention and is a portal set up to enable each designer using the present invention to group together its projects.

FIG. 15 is a screenshot of the platform of the present invention and is a portal set up to enable users to view various products grouped by collection and with pricing data for budget analysis.

FIG. 16 is a screenshot of the platform of the present invention which enables new products to be entered into the product database according to the present invention.

FIG. 17 is a screenshot of the platform of the present invention which enables the entering of the project budget.

FIG. 18 is a screenshot of the platform of the present invention which enables the budgeting tool with multiple interactions according to the present invention.

FIG. 19 is a screenshot of the platform of the present invention which shows a list of statuses.

FIG. 20 is a screenshot of the platform of the present invention which shows the status set of a product.

FIG. 21 is a screenshot of the platform of the present invention which shows a list of comments and statues on the product overlay.

FIG. 22 is a screenshot of the platform of the present invention which shows a product overlay with a calendar for specific status change.

FIG. 23 is a screenshot of the platform of the present invention which shows the product tile with a calendar.

FIG. 24 is a screenshot of the platform of the present invention which shows the workspaces module project overview page.

FIG. 25 is a screenshot of the platform of the present invention which shows the panel to add a new workspace and add items to that workspace.

FIG. 26 is a screenshot of the platform of the present invention which shows the workspaces module project overview page with product status.

FIG. 27 is a screenshot of the platform of the present invention which shows the workspaces module project overview page for room and product details.

FIG. 28 is a flow diagram of the application image upload process flow.

FIG. 29 is a flow diagram of the mobile manual image categorization process.

FIG. 30 is a flow diagram of image categorization aided by AI machine learning.

FIG. 31 is a diagram of the revenue model of the present invention.

FIG. 32 is a diagram of projected annual revenue growth of the present invention.

### DETAILED DESCRIPTION OF THE PREFERRED EMBODIMENT

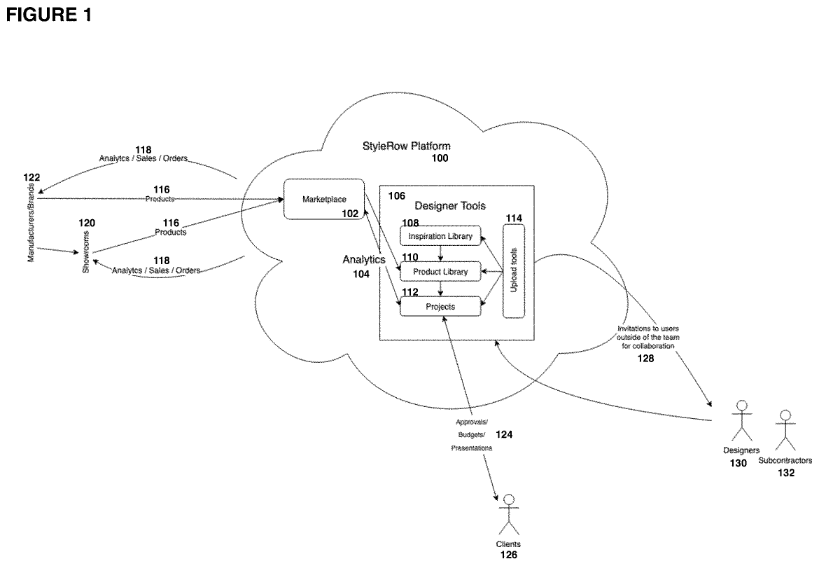

FIG. 1 is a diagram of user flow through the platform of the present invention. In accordance with the preferred embodiment of the present invention, the platform 100 consists of an online marketplace 102, analytics engine 104 and designer tools 106. The online marketplace 102 is used by manufacturers and brands 122 as an online extension of their physical showrooms 120, whereby they can market and sell their physical products 116 on the platform marketplace 102. The platform marketplace 102 provides feedback to manufacturers and brands 122 by providing analytics, sales and orders 118 from the platform 100. Items from the marketplace can be stored in the product library 110 within the designer tools 106. The marketplace 102 also shares analytics data 104 with the projects module 112 of the designer tools 106. The projects module 112 features project approvals, budgets and presentations 124 that can be viewed by the client 126. Designer tools 106 consist of an inspiration library 108, a product library 110, and saved projects 112. The designer tools 106 also feature an upload tools functionality 114 that allows for designer 130 and subcontractor 132 users to upload new items to the designer tools 106. The designer tools can also be accessed through invitations 128 by users outside of the design team for collaboration.

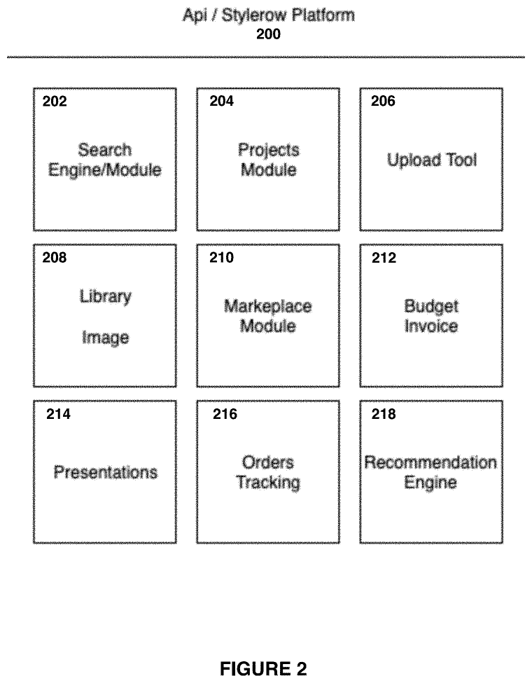

FIG. 2 is a diagram of the Application Programming Interface (API) of the platform of the present invention. In accordance with the preferred embodiment of the present invention, the platform API 200 consists of: a search engine module 202; a projects module 204; upload tools 206; an image library 208; a marketplace module 210; a budget and invoicing module 212; a presentations module 214; an orders and tracking module 216; and a recommendation engine module 218.

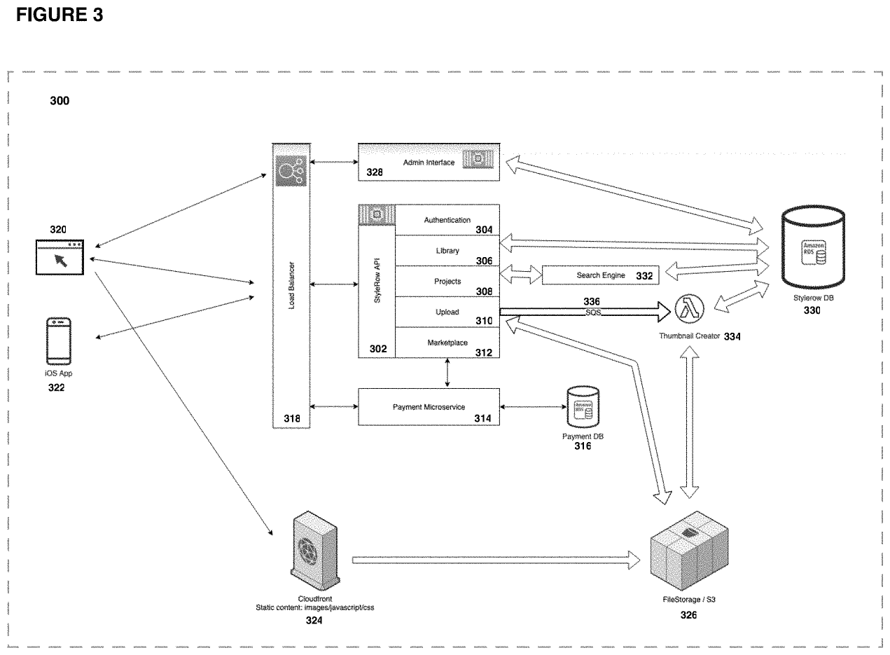

FIG. 3 is a diagram of the platform architecture of the present invention. In accordance with the preferred embodiment of the present invention, the overall platform architecture 300 is centered around the platform API 302. The platform API 302 consists of: an authentication engine 304; an image library 306; designer projects 308; upload functionality 310; and the product marketplace 312. The image library 306 is stored in the File Storage 326. Meta-information about images is stored in the Database 330. The platform database 330 communicates with the admin interface. The projects module 308 uses a Search Engine to optimize search time across different products. Search Engine in turn uses database 330 as the source of information. The platform upload functionality uploads data into the file storage 326 and then uses SQS to communicate with the thumbnail creator 334. Meta information about images and thumbnails and their relations with specific products are stored within the platform database 330. The product marketplace 312 facilitates purchase orders through a payment microservice 314 that interfaces with an external provider to process credit cards. Additionally, microservice 314 uses payment database server 316 to store information about purchases. Users can access the platform via API 302, admin interface 306 and payment microservice 314 through the load balancer 318 using either online browser 320 or mobile phone application 322. External cloudfront server 324 is used as CDN (Content Delivery Network) to speed up delivery of a static content such as images, thumbnails, javascript, css-files to end user.

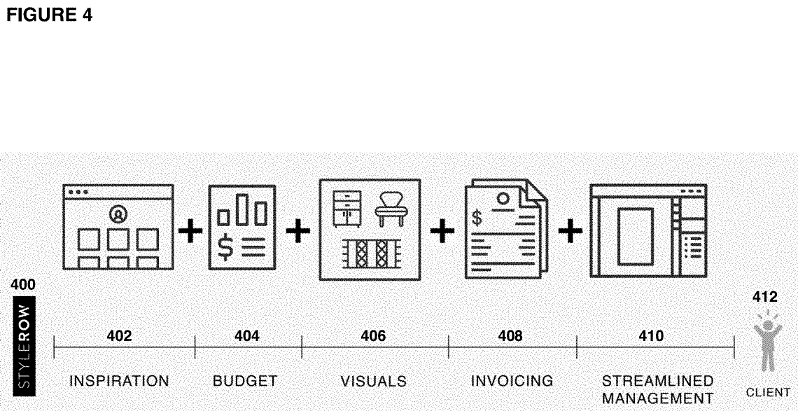

FIG. 4 is an overview of the services of the present invention. In accordance with the preferred embodiment of the present invention, the platform 400 is able to provide a multitude of services in one platform to the client 412. The platform 400 can: save and aggregate client ideas for designer inspiration 402; create and track project budgets 404; provide visuals of products 406 for the client project; allow the designer to invoice 408 the client for the project; and streamline all aspects of project management 410.

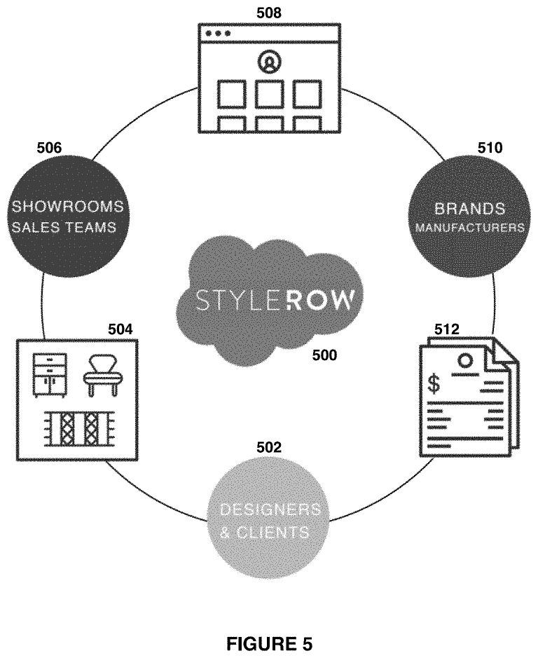

FIG. 5 is an overview of various user services of the present invention. In accordance with the preferred embodiment of the present invention, the platform 500 allows for designers and clients 502 to save products to an image library 504. The image library features products from showrooms and sales teams 506, that populate the platform marketplace 508 with said products made available for sale. The marketplace 508 consists of brands and manufacturers 510, which profit from sales 512 of their products on the marketplace 508 and purchased by designers and clients 502. Designers also have the option of creating an e-commerce from their own product library. The product library can be curated for internal use for designer clients and projects, with the option to turn the designer product library into a consumer facing e-commerce store. The designer can incorporate their own pricing margin to the items curated in the product library with the ability to resell these items to a wider audience. Designers can use this e-commerce option to sell curated items without the need to have a contractual client project agreement with said consumers.

Importantly, various user interfaces well known in the art may be deployed to accommodate any number of key stakeholders according to the present invention. For example, smartphones via iOS or Android, tablets, associated with or with standalone cameras may capture video images for uploading to and transmission from the platform according to the present invention. Likewise, audio notes or transcriptions or GPS data may be uploaded and downloaded for “geo-tagging” available resources or even their position within the supply chain. Notably, key stakeholders may each have access to the system according to the present invention so that clients, internal design teams, vendors or suppliers, 3PL interests or shippers and installers in the field are all synchronously informed and polled to make certain that client expectations are met and that all status reports of ongoing activity are updated in real-time or period as desired. Importantly, the present invention may be modified to include any number of key stake holders, so that fixed and mobile resources may be deployed as needed globally, and alerts as to time and geo-fencing as to position established for all desired status and monitoring of conditions. It is well known in the art that RFID technology, for example, may be used to track resources in real time globally and with the advent of tracking systems which utilize artificial intelligence, such systems will dramatically improve as a user group according to the present invention utilizes the present invention. One example of a personalized artificial intelligence is provided by Amazon, consisting of loading data, inspecting data, identifying features, selecting or creating algorithms, selection of hyper-parameters, training models, building feature stores, hosting models and creating real time caches. However, it is also anticipated that the current invention will play a substantial role in migrating its users, for the very first time, away from physical record keeping (handwritten notes, photocopies and magazine clippings, etc.) to electronic media. Consequently, economies of scale may be rapidly achieved, according to the present invention, by for the first time utilizing the input parameters of each stakeholder: cameras, GPS transceivers, local and cloud memory, audio recording and transcription resources, geo-tagging, RFID resources and other 3PL data resources, and most importantly, the synchronous data management between all key stakeholders as defined on a real time or near real time basis globally.

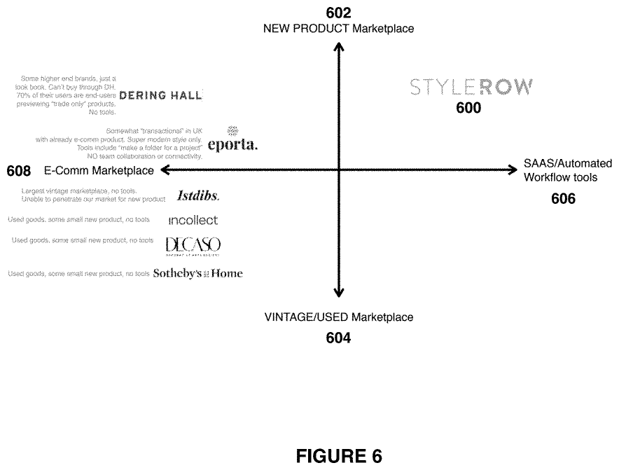

FIG. 6 is a diagram of the platform of the present invention in relation to other current platforms and services. In accordance with the preferred embodiment of the present invention, the platform 600 is based on providing users with new products from an online marketplace 602 (as opposed to a vintage marketplace 604), while also providing users with a variety of automated workflow tools 606. Other similar web-based programs are primarily centered around providing an e-commerce marketplace 608, with a lack of SAAS workflow tools 606 for users.

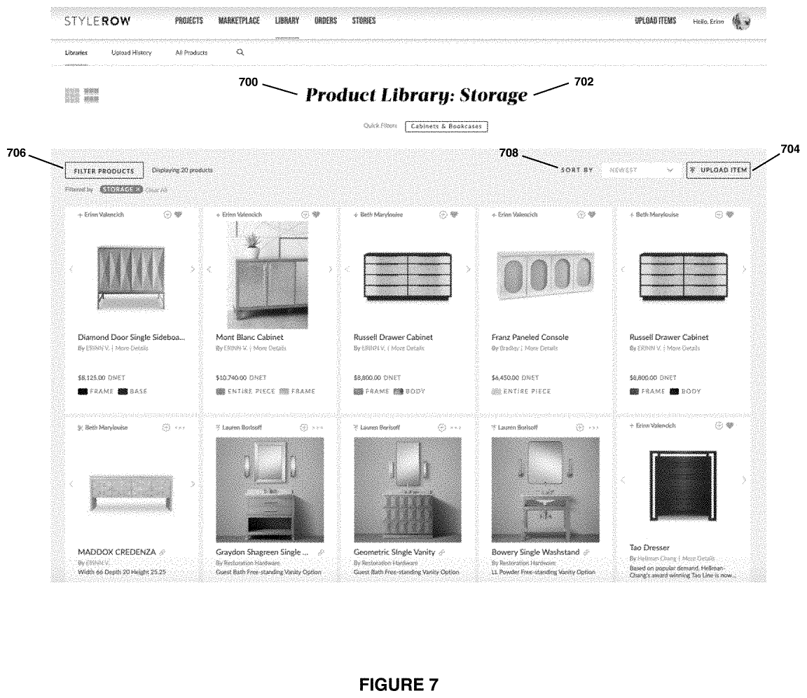

FIG. 7 is a screenshot of the platform of the present invention relating to the digital library storage as to available products or design elements. The product library 700 allows the user to aggregate and view images and information of all products that may be used in a design project. Products stored in the product library can be categorized 702 based on the type of product, for example: furniture pieces that are primarily used for storage and display, further categorized to cabinets and bookcases. The user is able to upload 704 any product to the product library 700. The user can filter 706 all products based on specific factors and sort 708 the displayed products based on specific parameters. Items can also be filtered by what each individual team member has uploaded to the digital library. This feature helps with the on-boarding process of new team members on the design team, as these new members are able to now have a cohesive visual reference of the design firm's aesthetic by easily viewing what has been uploaded to the library by higher level senior designers. The digital library eliminates the need for saving documents on multiple platforms by allowing all design team members to collaborate on products that they want to use and sell.

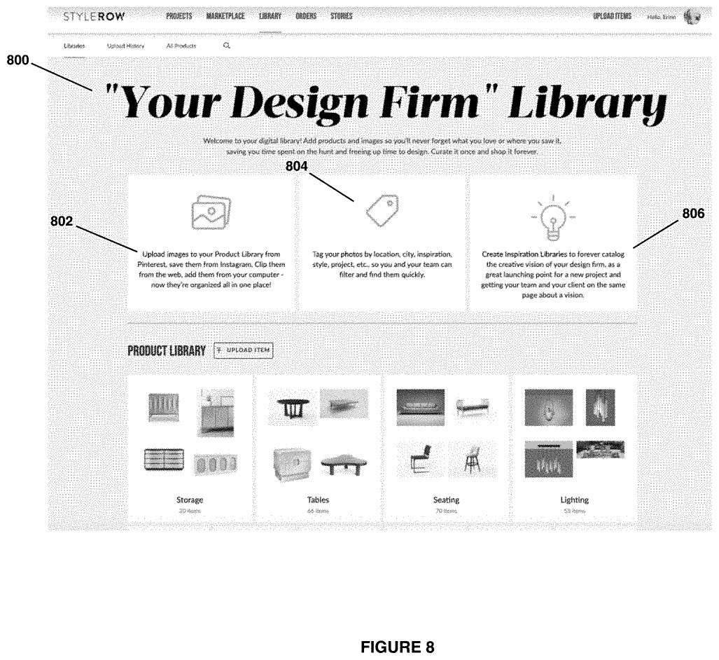

FIG. 8 is a screenshot of the platform of the present invention depicting a design firm's product library or inventory. The design firm product library 800 allows the designer user to upload 802 and save any products that can serve as inspiration for designer projects. The products uploaded 802 to the product library 800 can be tagged 804 so that they can be found easily. Product filters 804 include but are not limited to: location; city; inspiration; style; and project. The designer can create inspiration libraries 806 to catalog the overall creative vision of the design firm, and envisioning a new project for a client.

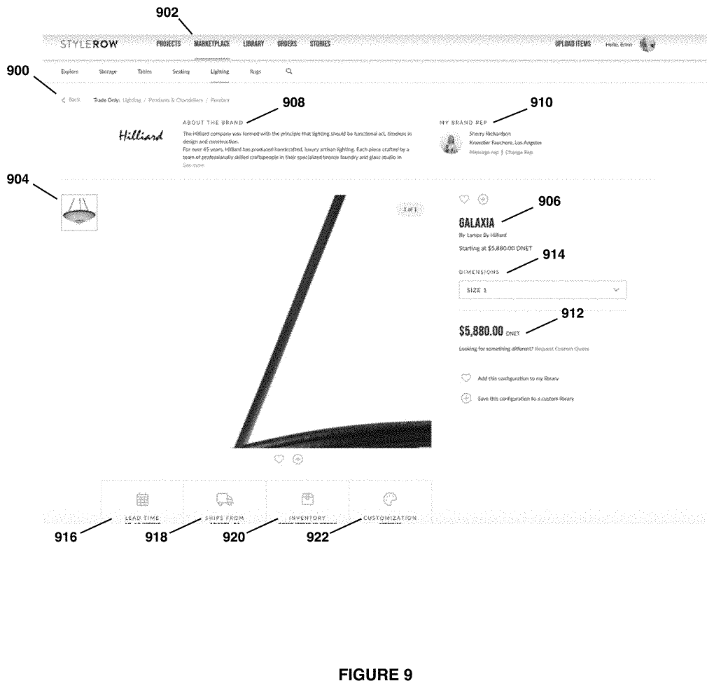

FIG. 9 is a screenshot of the platform of the present invention depicting detailed information about a product. Clicking on a product will allow the user to access an information page 900 for each product in the marketplace 902. The information page contains multiple images of the product 904, as well as the model name of the product 906 , information about the brand selling the product 908, and a contact link to message the sales representative for the brand 910. The product information page 900 also lists the Designer Net (DNET) wholesale price of the product 912 and product dimensions 914. Additional relevant information can also be listed, such as: the product lead time 916; where the product is shipped from 918; inventory information 920; and customization options 922 available to the designer.

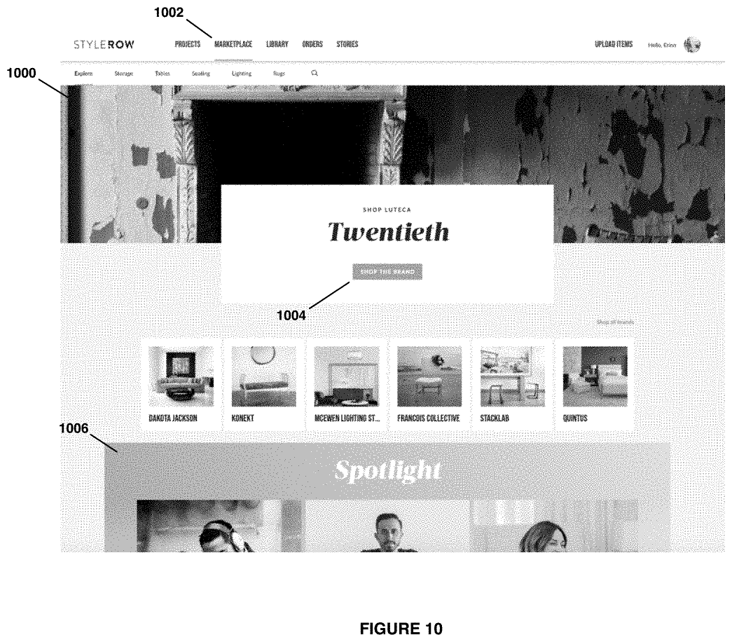

FIG. 10 is a screenshot of the platform of the present invention depicting an online retailer collection of product offerings available to users of the platform according to the invention. The brand page 1000 for every marketplace 1002 online retailer allows for the designer to browse and shop 1004 for all other products sold by a specific brand. The brand page 1000 also features information on the brand and product designers through the brand spotlight 1006, allowing the designer to learn more about the brand and whether or not it fits with the designer's vision.

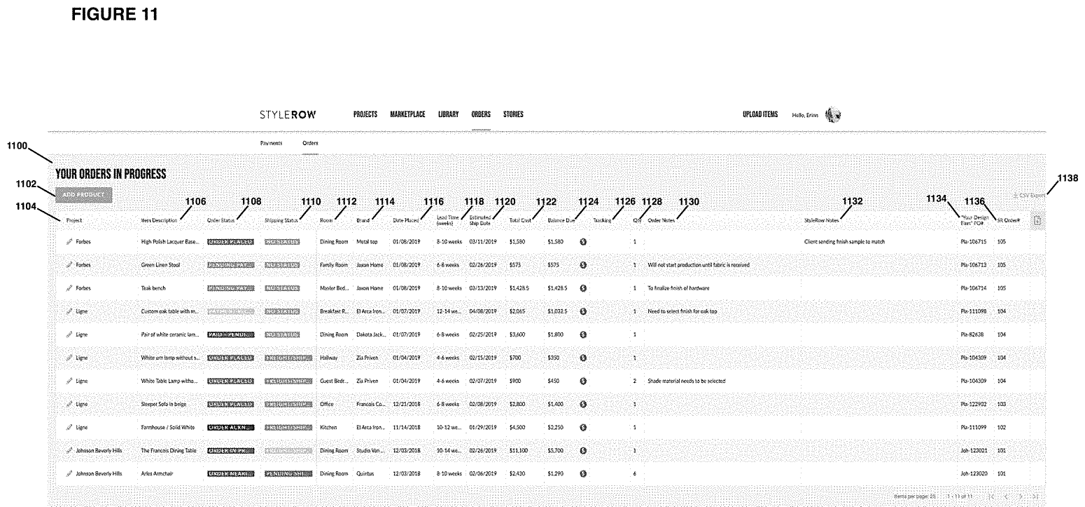

FIG. 11 is a screenshot of the platform of the present invention wherein various client orders are being tracked according to the present invention. All client orders in progress can be tracked by the designer through the orders in progress page 1100, allowing the designer to track all active orders in one page. The designer can also manually add products 1102 to the active orders page 1100. Each active order displays the following information: the name of the project 1104; a description of the ordered item 1106; the current status of the order 1108 in real time; the shipping status of the order 1110; the room the item is to be placed in 1112; the product brand 1114; the date the order was placed 1116; the order lead time 1118 displayed in weeks; the estimated shipping date of the order 1120; the total cost of the product 1122; the balance due 1124; tracking information 1126 once the order has shipped; quantity of products in the order 1128; order notes 1130 from the vendor, additional notes 1132 made by the designer; the design firm's purchase order (PO) number 1134; and the platform (SR) order number 1136. The user also has the option of downloading the order summary as a spreadsheet in csv format 1138. Importantly, information pertaining to vendors, shipping or 3PL or installation in the filed may be entered into the overall material and workflow according to the present invention. Once the designer orders through the platform of the present invention, the order is automatically entered and tracking is enabled in the system. The system then automatically follows up on the order based on the parameters of the sale, such as lead time, etc. Showroom and manufacturer user groups can login to the system and edit certain order details such as: lead time, the remaining balance due, and tracking information. The central order database system of the present invention allows for all three stakeholders, the designer, the showroom and sales team, and the brand, to access order information simultaneously without the need for additional external software.

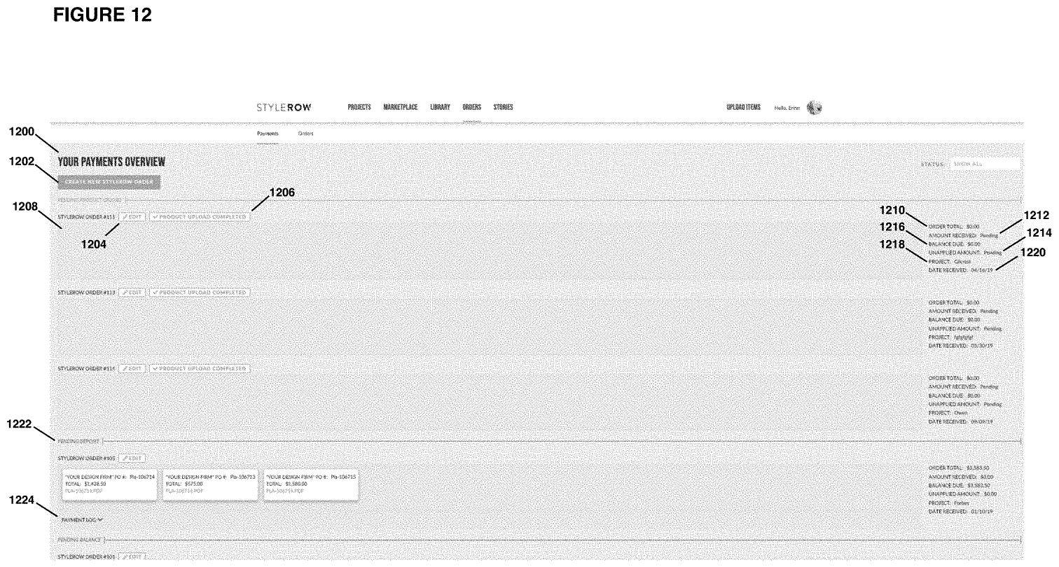

FIG. 12 is a screenshot of the platform of the present invention wherein various client payments are being tracked according to the present invention. The payments overview page 1200 allows the user to enter new client payments manually 1202, as well as edit 1204 client payments and upload additional client products 1206 that are pending payment. The payments overview page 1200 can be used to track client payments, as well as vendor payments and shipping payments in one place. Each pending order 1208 displays information such as: the total amount of the order 1210; the amount received 1212; the balance due 1216; the unapplied amount 1214; the name of the project 1218; and the date the payment was received 1220. The user can also track pending deposits 1222 on an order through the payment log 1224.

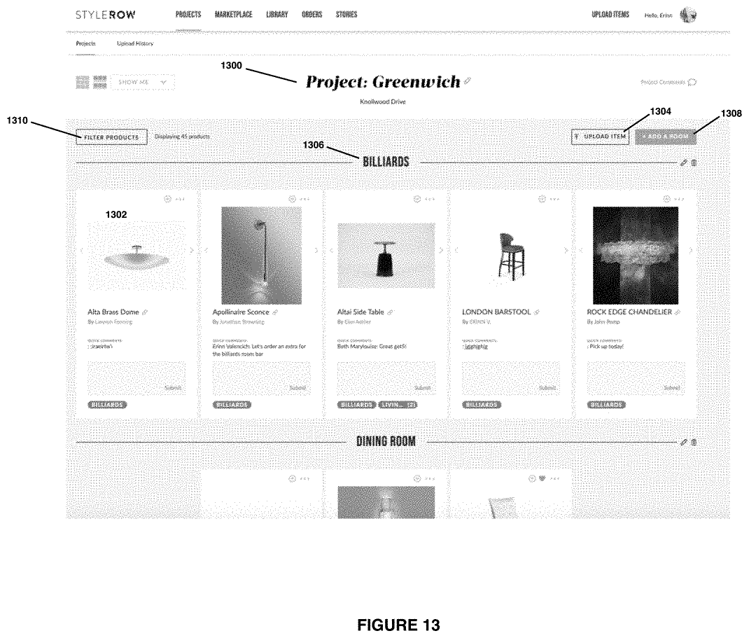

FIG. 13 is a screenshot of the platform of the present invention wherein an entire client project progress is being tracked according to the present invention. Each client project has a dedicated page 1300 that displays the products 1302 that have been uploaded 1304 and categorized by the specific room 1306 that product is meant for. Designers also have the ability to add rooms 1308 to the project as needed. The products displayed can also be filtered 1310 by designated product keywords.

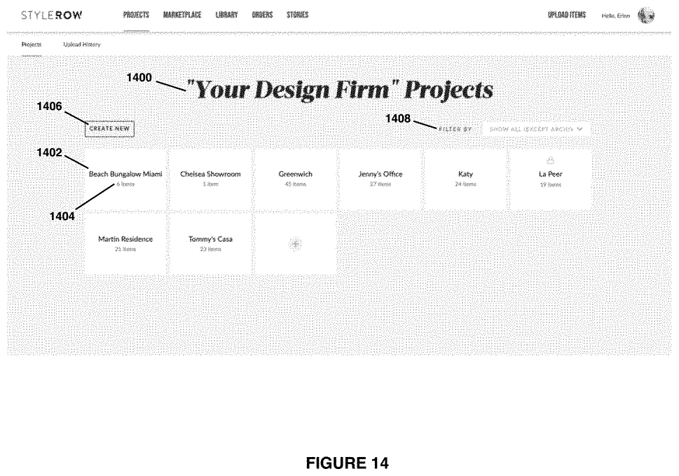

FIG. 14 is a screenshot of the platform of the present invention and is a portal set up to enable each designer using the present invention to group together its projects. The projects overview page 1400 shows the name of each project 1402 and the number of items 1404 that have currently been selected for that project. The user can create new projects 1406 and filter projects 1408 based on set filtering parameters such as keywords.

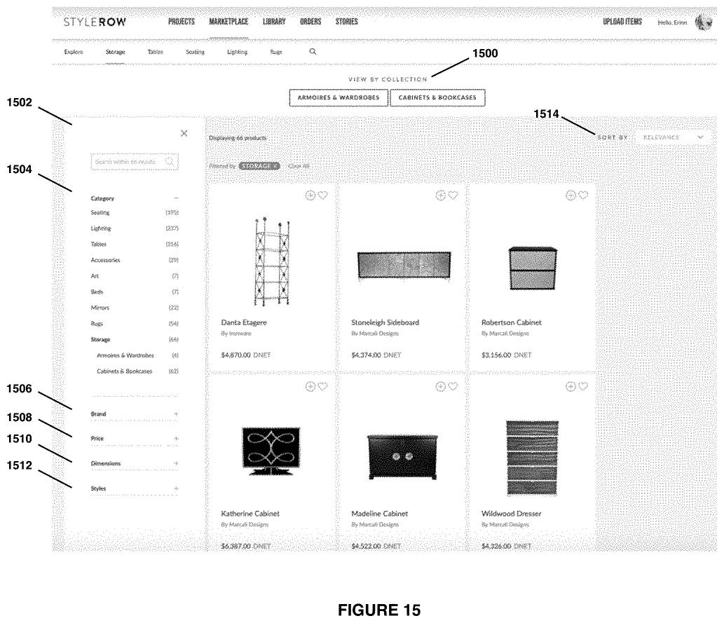

FIG. 15 is a screenshot of the platform of the present invention and is a portal set up to enable users to view various products grouped by collection and with pricing data for budget analysis. The product collection page 1500 can be searched 1502 by: the product type 1504 (for example, storage furniture); the brand 1506; the product price 1508; the product dimensions 1510; or the style of the product 1512. The products can also be sorted 1514 in order by designated parameters such as relevance.

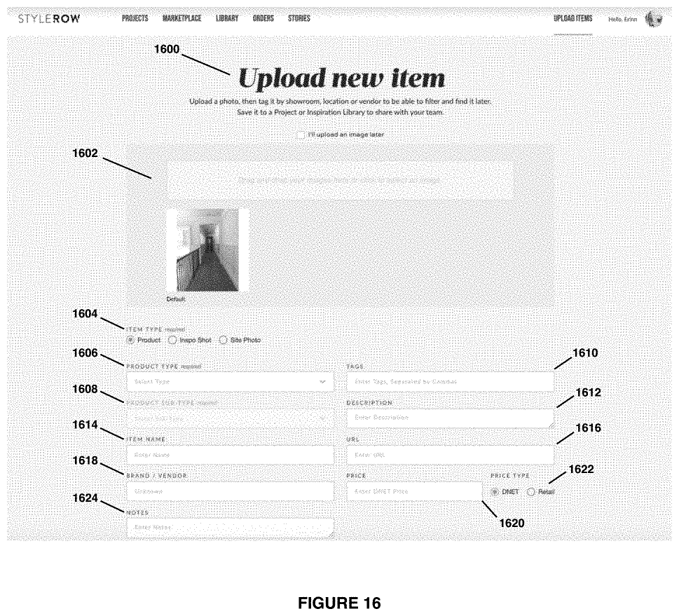

FIG. 16 is a screenshot of the platform of the present invention which enables new products to be entered into the product database according to the present invention. The product upload page 1600 allows the user to upload 1602 an image and select the item type 1604 (for example, if the uploaded image is a product, design inspiration, or image of the project site). If the uploaded image is a product, the user is required to enter the type 1606 of product to allow for image categorization, with the option of also adding a product sub-type 1608. The user can also add tags 1610 to enable search filtering, and a description of the product 1612. Additionally, the user can add other relevant product information such as: the name of the item 1614; the web address uniform resource locator (URL) 1616 of the product; the brand or vendor 1618 selling the item; the item price 1620 ; the price type 1622 such as the designer (DNET) price or the retail price; and any other additional user notes 1624.

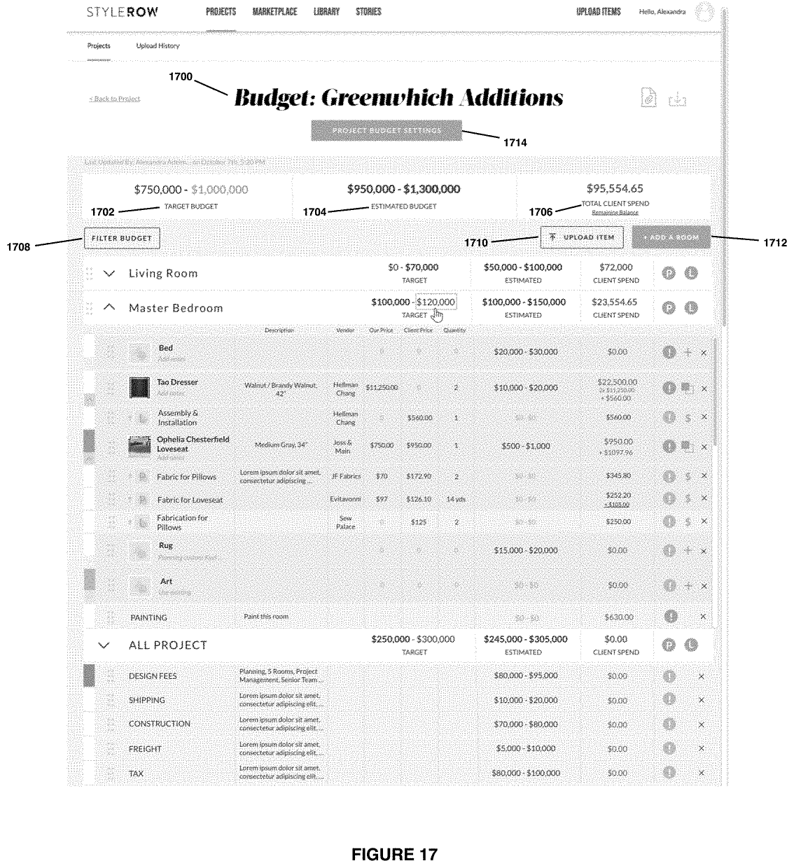

FIG. 17 is a screenshot of the platform of the present invention which enables the entering of the project budget. The project budget page 1700 is a budgetary overview for one client project. It shows the target budget 1702, the estimated budget 1704, and the total client spend 1706 to date. The user can filter 1708 the budget grid based on certain set parameters, upload new items 1710 and add additional rooms 1712 to the budget. The user can also edit the project budget settings 1714 to customize the budget overview as they see fit. The budget page can also be set to alert the user once specified parameters have been exceeded. This budget threshold alert can be used as products are being added to the project. If the budget threshold is triggered, the user can edit the costs in order stay within the budget and avoid having to go back to manually re-calculate later. Designers are able to view the budget for each room of the project. Filters can also be applied to the budget. These filters can be based on key words that narrow the budget down to a specific type of product. These filters can also be based on status, for example, payment or installation status.

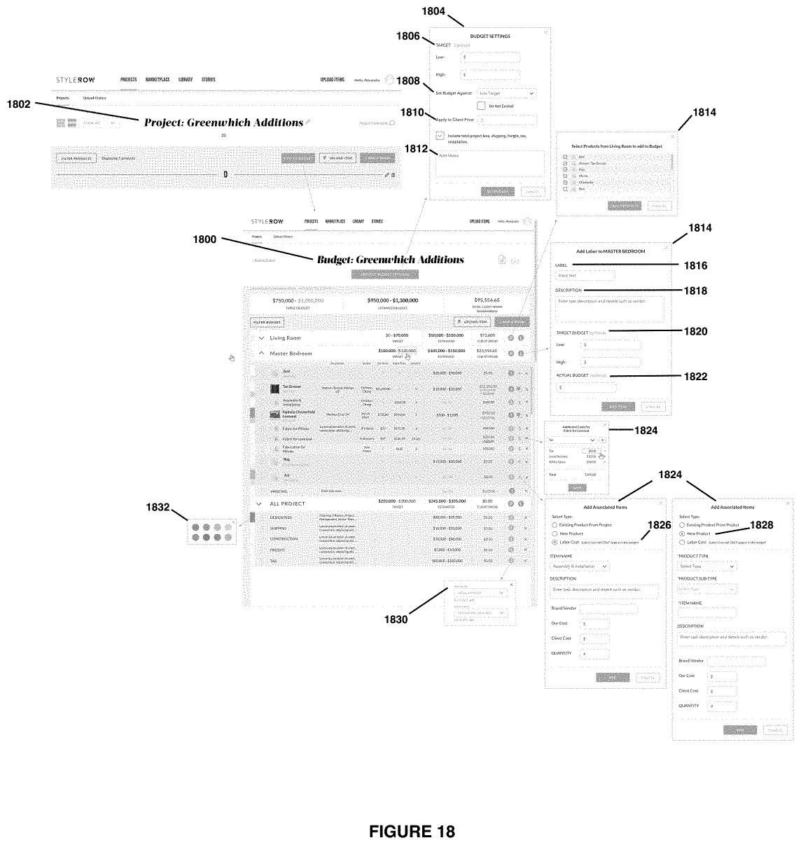

FIG. 18 is a screenshot of the platform of the present invention which enables the budgeting tool with multiple interactions according to the present invention. The project budget page 1800 can be accessed through the project overview page 1802. The user can edit the project budget page 1800 by accessing the project budget settings panel 1804. The user can set up optional target budget parameters 1806, ranging from a low to high figure. The user can also set the budget against a specific target amount 1808. The user can apply a percentage-based client price 1810, and include budget notes 1812.

Within the project budget page 1800, the user can also select specific products from each room to add to the budget 1814. From the project budget page 1800, the user can also add in the cost of labor 1814 to each room of the project. The labor budget panel 1814 allows the user to enter a label for the labor 1816, add a description of labor 1818, add in a target labor budget 1820, and enter the actual labor budget 1822.

Within the project budget page 1800, the user can also add any additional cost for each product in the budget 1824, such as additional taxes and customization costs associated with each product. Also within the project budget page 1800, the user can add associated items to each product in the budget 1824. These associated item costs can include the cost of additional labor 1826 or any new items 1828 that are associated with a particular product.

Within the project budget page 1800, the user can view the budget status 1830 of each stage of the project, including the team status and the client status. The user can also customize the project budget page even further by color coding 1832 the stage the budget.

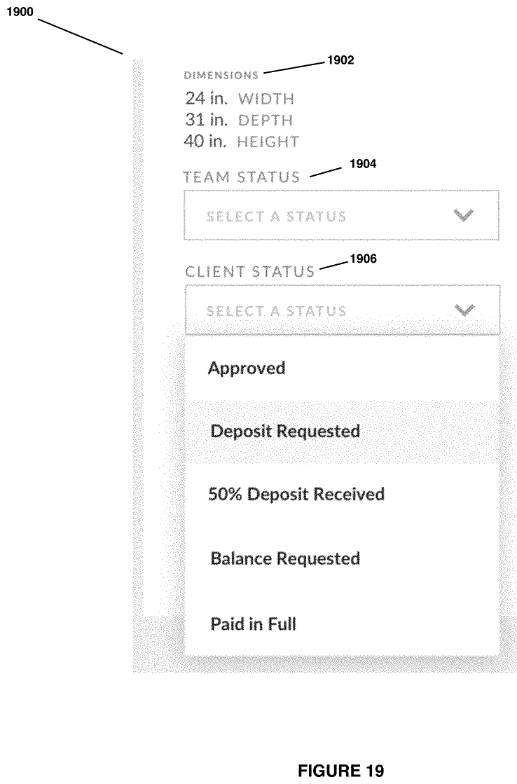

FIG. 19 is a screenshot of the platform of the present invention which shows a list of statuses. The status panel 1900 displays the dimensions 1902 of a specific space. The status panel also shows the current internal team status 1904 as well as the client status 1906 (i.e., client approval, deposit requests, balance requests, and client payment status).

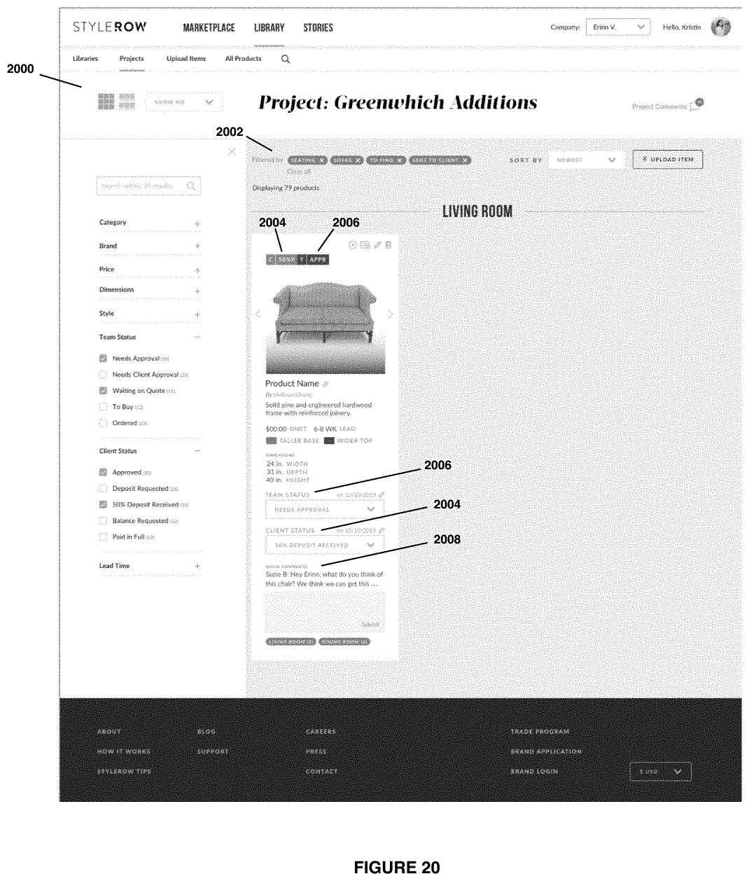

FIG. 20 is a screenshot of the platform of the present invention which shows the status set of a product. The status of every product added to a project can be viewed on the individual product status set page 2000. Each product can be filtered 2002 based on set parameters or keywords. Each product shows the client funding status 2004 for that product, as well as the approval status 2006 of the design team. The user can also view, add and respond to comments 2008 from other users related to that specific product.

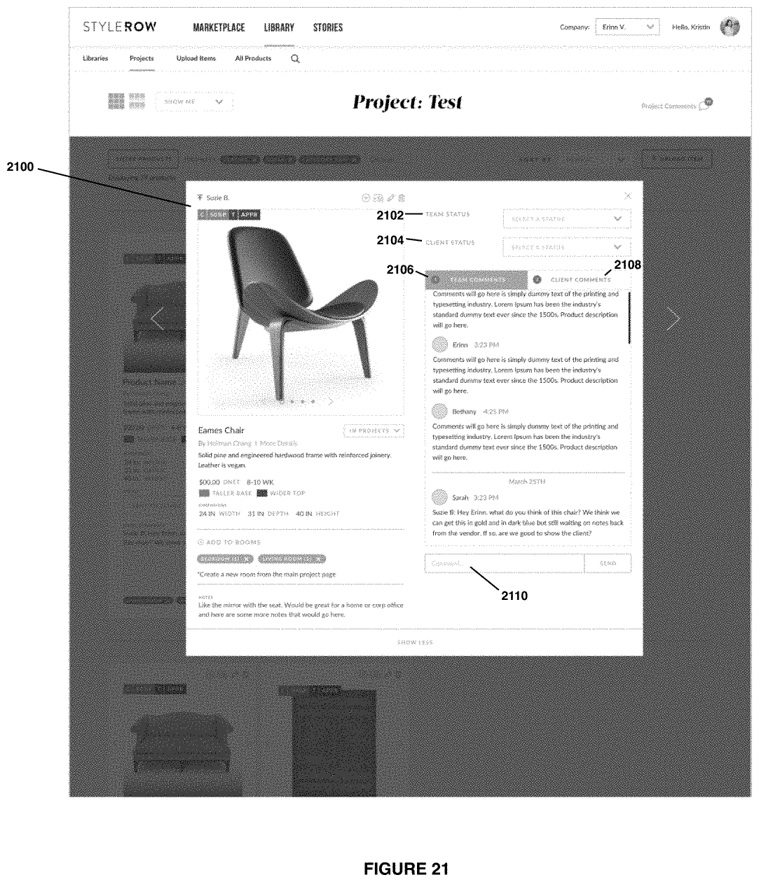

FIG. 21 is a screenshot of the platform of the present invention which shows a product overlay with comments. The product overlay comment panel 2100 allows the user to view the team status 2102 and client status 2104 for each product in the project. The user can also view comments left by the team 2106 and comments left by the client 2108 for each product, as well as enter new comments 2110 for each product.

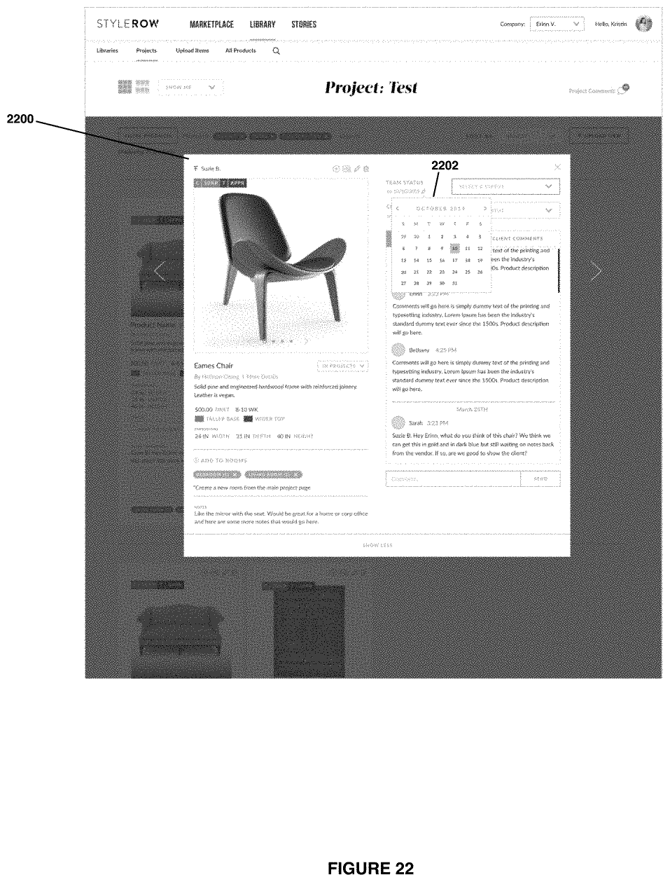

FIG. 22 is a screenshot of the platform of the present invention which shows a product overlay panel with a calendar. The product overlay panel 2200 also features a calendar function 2202 that allows the user to update the status date on a monthly calendar for each product used in the project.

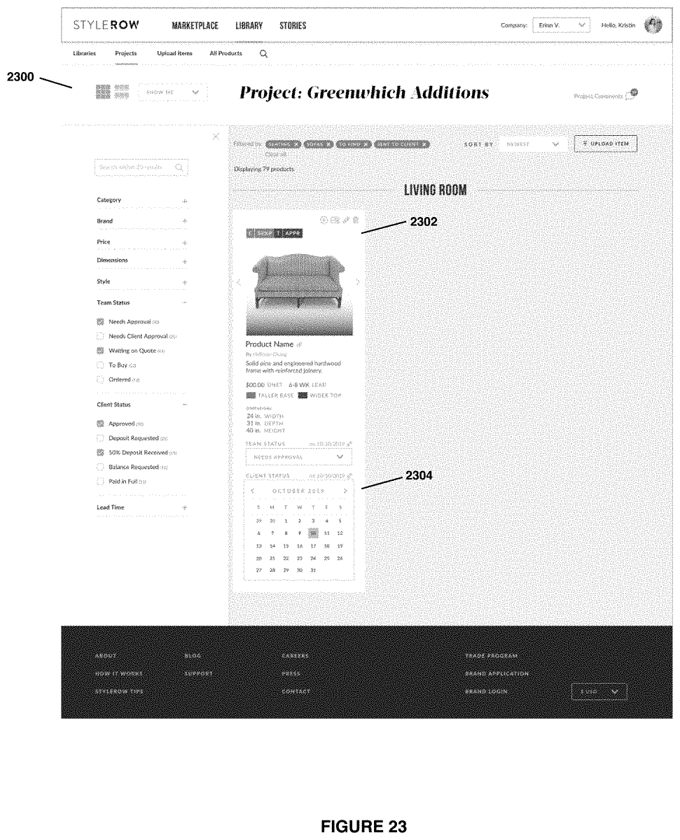

FIG. 23 is a screenshot of the platform of the present invention which shows the product tile with a calendar. The status of every product added to a project can be viewed on the individual product status set page 2300. The individual status page panel for 2302 for a product also features a calendar function 2304 that allows the user to update the status date on a monthly calendar for each product used in the project.

The preferred embodiment of the present invention also features workspaces in the workflow software of the present invention. These workspaces are formed within the connective UI/UX layer and facilitate how each of the five key user groups interact within the workflow of the platform of the present invention. Also, these workspaces can accommodate thir¬d party systems through a data push (one way or two way) including EDI/ERP via APIs of the present invention.

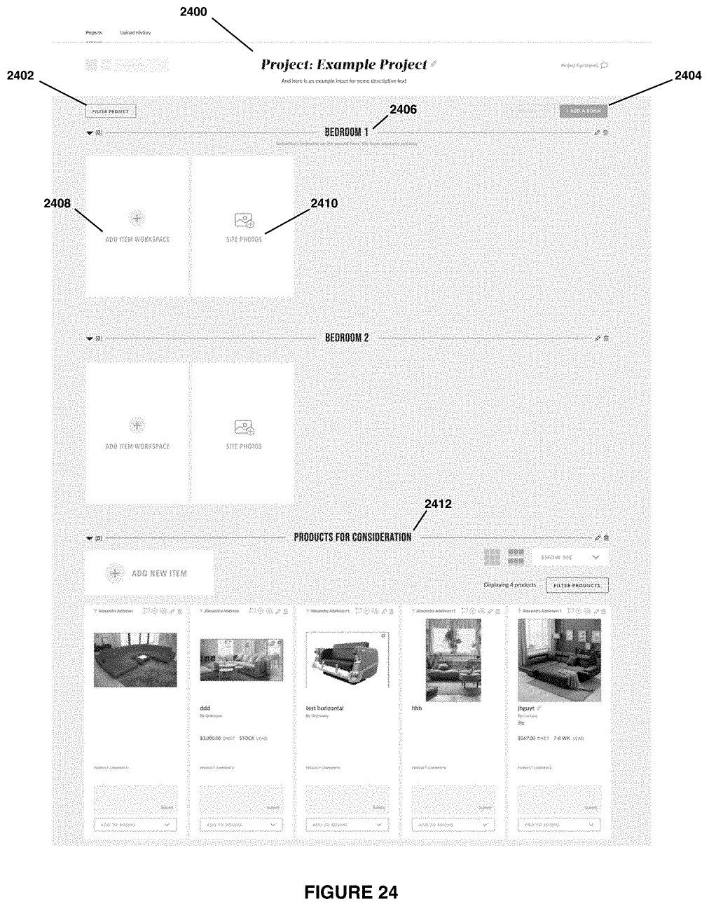

FIG. 24 is a screenshot of the platform of the present invention which shows the workspaces module project overview page. The project overview page 2400 of the workspaces module allows the user to divide a design project up by rooms 2406, with the option to add rooms as needed 2404. The user adds products or items 2408 to each room. The user can also upload photos of the site or room 2410 to serve as design references. The workspaces overview page 2400 features a filtering function 2402, based on parameters such as filtering by room type, item or product type, inspiration images and site photos. The workspaces project overview page 2400 also features a section of products for consideration 2412 that have not been assigned to a specific room but are saved in the workspace for reference.

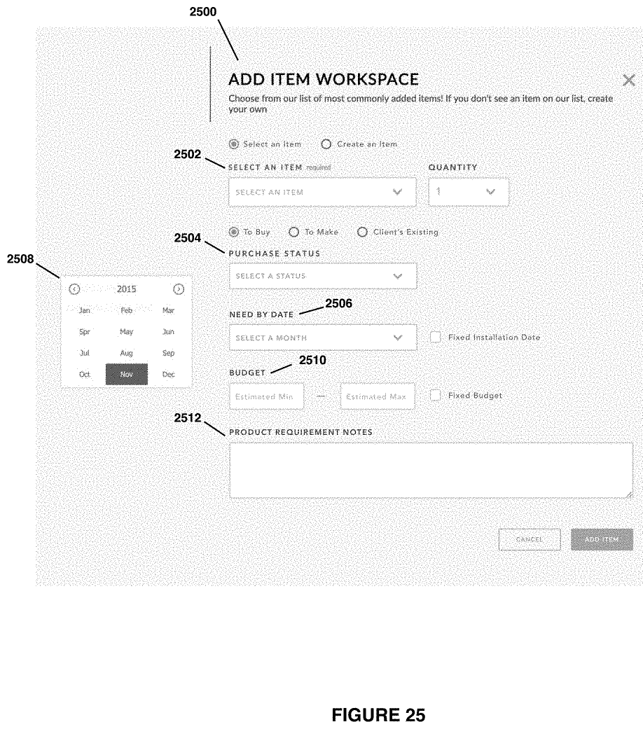

FIG. 25 is a screenshot of the platform of the present invention which shows the panel to add a new workspace and add items to that workspace. The add workspace panel 2500 allows the user to select or create a new item 2502 to be uploaded to the new workspace. This panel guides the user to set the parameters for the items they need for the project. The user can then specify the purchase status 2504 of the item, if the item is to be made or if it is already owned by the client. The user can then specify a date that the item is needed by 2506, using a calendar function 2508. The user can also enter the estimated or fixed budget 2510 for the item, and add any additional notes 2512 related to the item. In terms of project management, the workspaces feature user notes and commenting functionality that allows designers to easily leave notes or comments for personal reference or to be viewed by other team members. New notes or comments for the team can show up in a different color so that each team member is aware that new notes have been added for review. Team members can use color-coded text or different font sizes in order to visually differentiate notes based on priority. This improves on current efficiency software that lacks the options for the user to color code or customize font size, resulting in some notes or comments being overlooked by other team members.

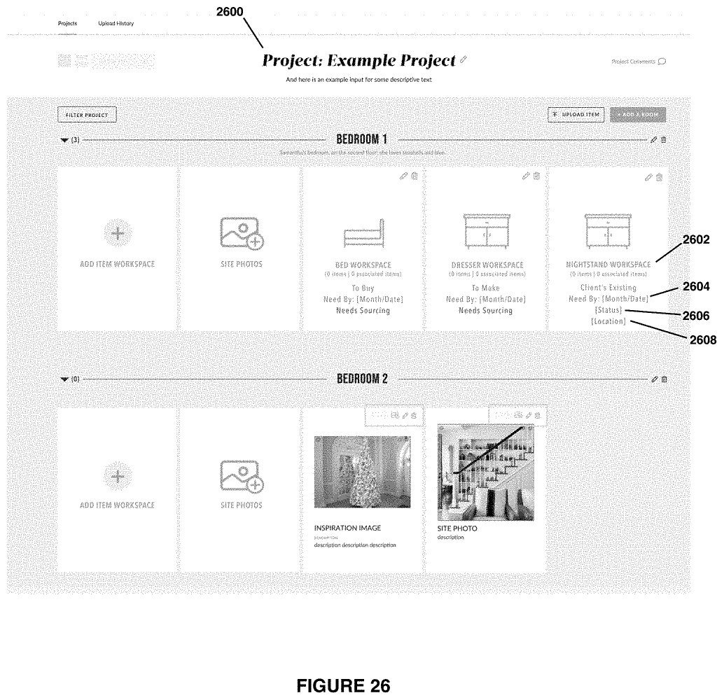

FIG. 26 is a screenshot of the platform of the present invention which shows the workspaces module project overview page with product status. Each item 2602 added to the workspaces project overview page 2600 displays: the procurement status of the item (i.e., if the item is to be purchased, to be made, or if it is already owned by the client) and date that the item is needed by 2604; the source status of the item 2606; and the current location of the item 2608.

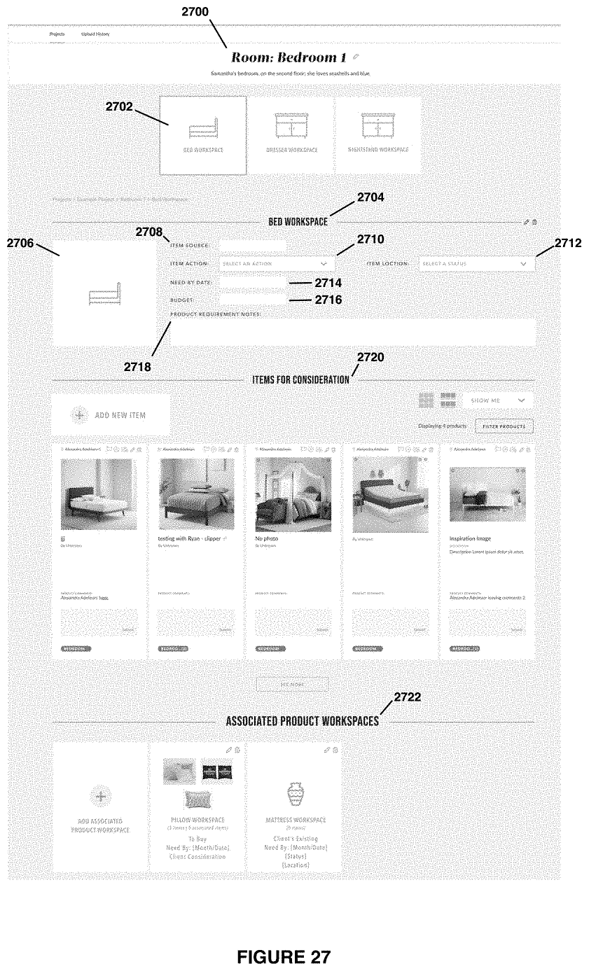

FIG. 27 is a screenshot of the platform of the present invention which shows the workspaces module project overview page for room and product details. Within each room page 2700 in the workspaces module, sections of the room can be sub-divided into additional workspaces based on the item or area in the room 2702. An item workspace 2704 can display: the image of the item or area of the room 2706; the item source 2708; the item action or status 2710; the item location 2712; the need by date for the item 2714; the budget for the item 2716; and product requirement notes for the item 2718. Each item can workspace 2704 also have a section of items for consideration 2720 related to that specific item or area workspace. Each item workspace 2704 can also have associated product workspaces 2722 that are related or relevant to the design of that specific item or room area. These workspaces also serve as a workflow tool, where users can choose items for each workspace, and then promote certain selected items that will be purchased. These promoted items are then re-ordered so that they are displayed at the top of the workspace, in order to facilitate workflow and project efficiency. All relevant data is then re-ordered in the workspace based on the status of an item, such as: quoting phase; sharing phase; ordering; shipping; and installation.

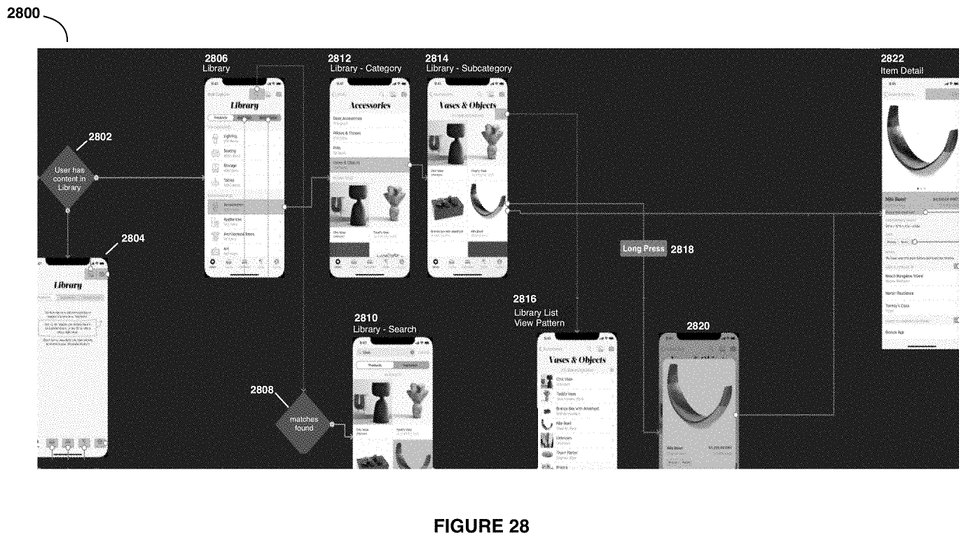

FIG. 28 is a flow diagram of the application image upload process flow. Using the image upload module 2800, the user can upload content to the library if no content has been previously uploaded 2804, or access the content that has been previously uploaded 2802 by accessing the image library 2806 of the present invention. Images uploaded to the library 2806 are sorted by image categories that can be matched 2808 using the image library search module 2810. Once a category 2812 is selected, the user is presented with a list of subcategories 2814 to help refine image categorization.

Once a subcategory has been selected 2814, the user can access a list view all uploaded images 2816 that have been categorized within that subcategory 2814. The user can select an image from the library 2814 to view all details associated with that image 2822. The user can also select an image using a long press input 2818 in order to view a specific image from the subcategory in a different tab or image quickview 2820.

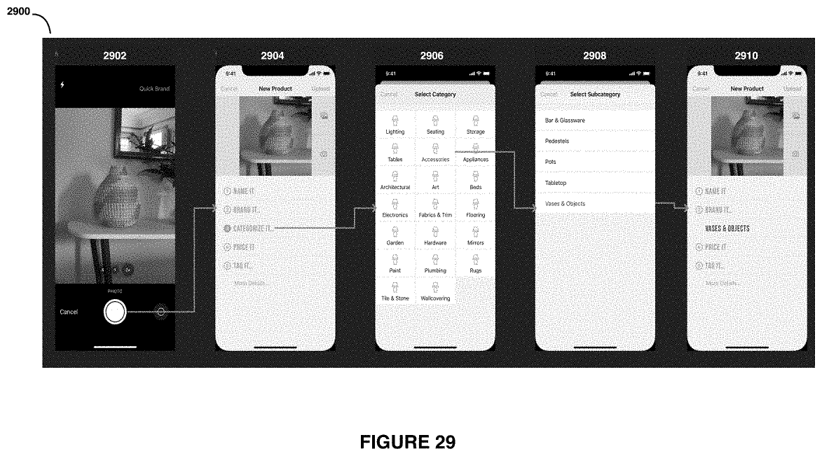

FIG. 29 is a flow diagram of the mobile manual image categorization process. The manual image categorization module of the present invention 2900 allows the user to manually capture an image 2902 using a smartphone camera. The image is uploaded to the image repository of the present invention as a new product 2904, whereby the user is prompted to categorize the image 2906 by selecting from a list of categories. Once a category 2906 has been selected for the image, the user can then manually select a subcategory 2908. Once the image has been manually categorized 2908, the user can also input additional details 2910 for the image such as the image name, brand, price and tag.

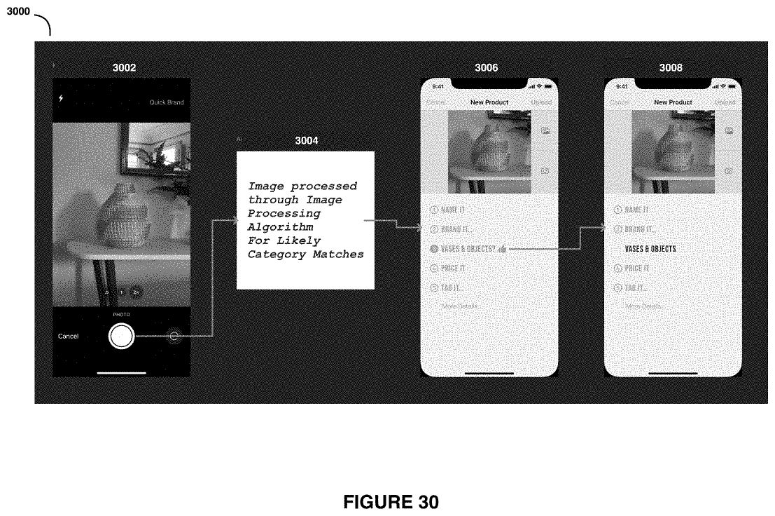

FIG. 30 is a flow diagram of image categorization aided by AI machine learning. In accordance with the preferred embodiment of the present invention, images can also be categorized through an AI categorization module 3000. An image can be captured 3002 using a smartphone camera. The captured image is processed through an artboard image processing algorithm for likely category matches 3004, based on similar previously uploaded and categorized images. The AI categorization module suggests a category 3006 that can then be confirmed by the user 3008.

The preferred embodiment of the present invention facilitates orders through Electronic Data Interchange (EDI), defined as the electronic interchange of business information using a standardized format, a process which allows one company to send information to another company electronically rather than with paper. Business entities conducting business electronically are called trading partners. Many business documents can be exchanged using EDI, but the two most common are purchase orders and invoices. At a minimum, EDI replaces the mail preparation and handling associated with traditional business communication, and standardizes the information communicated in business documents, resulting in a “paperless” exchange. Most companies create invoices using a computer system, print a paper copy of the invoice and mail it to the customer. Upon receipt, the customer frequently marks up the invoice and enters it into its own computer system. The entire process is a transfer of information from the seller's computer to the customer's computer.

A traditional document exchange of a purchase order normally takes between three and five days. The buyer makes a buying decision, creates and prints the purchase order, and mails this purchase order to the supplier. The supplier receives the purchase order and enters it into the order entry system. The buyer calls supplier to determine if purchase order has been received, or the supplier mails the buyer an acknowledgment of the order. EDI can minimize or eliminate the manual steps involved in this transfer. An EDI document exchange of a purchase order normally occurs overnight and can take less than an hour. The buyer makes a buying decision and creates the purchase order but does not print it. EDI software creates an electronic version of the purchase order and transmits it automatically to the supplier. The supplier's order entry system receives the purchase order and updates the system immediately on receipt. Then, the supplier's order entry system creates an acknowledgment an transmits it back to confirm receipt, resulting in greater order efficiency. The platform of the present invention incorporates several different purchase cycles, including but not limited to: client to designer; designer to showroom; showroom to brand; and brand to manufacturer.

EDI is the standardization of exchanging electronic business documents. This is one step of the process standardizing communication and documentation between two parties. Once that information is passed to one entity's internal system it can be synced or automated into Enterprise Resource Planning (ERP) systems such as NetSuite. ERP is a type of a system to facilitate the flow of information throughout all the business functions within the boundaries of the organization and to manage all the interactions to outside partners. ERP can be integrated into brand and showroom systems. EDI can be mapped out through the data feeds of the present invention to proprietary ERP systems developed by brands and showrooms to provide seamless integration of order processing, tracking and delivery through APIs of the present invention and third party EDI & ERP solutions.

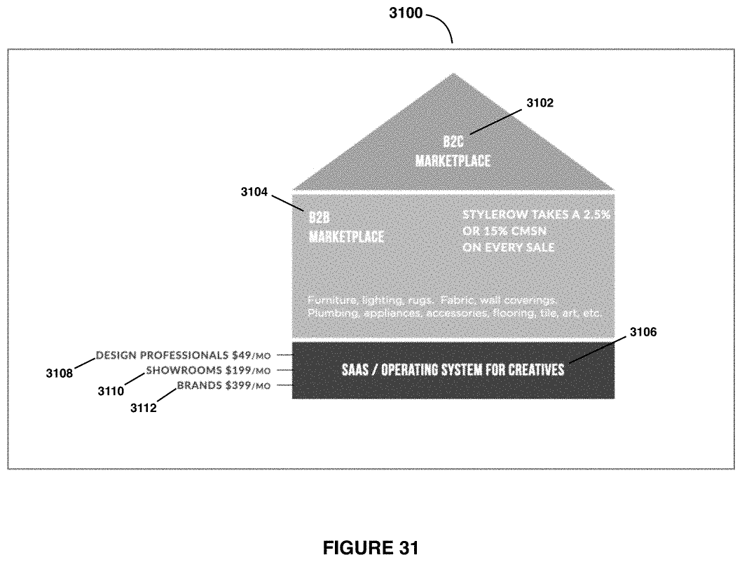

FIG. 31 is a diagram of the revenue model of the present invention. In accordance with the preferred embodiment of the present invention, the revenue model 3100, is comprised of: the business to consumer (B2C) marketplace 3102; the business to business (B2B) marketplace 3104; and the SAAS operating system for creative users 3106. At the top level, the B2C marketplace 3102 is the direct use of the platform of the present invention by the individual consumer. This marketplace is based on the shared interest to help businesses and creative users use the platform market their goods and services directly to the individual consumer.

At the mid-level, the B2B marketplace 3104 is the use of the platform of the present invention by businesses. This marketplace 3104 includes the sale of products such as: furniture; lighting; textiles; plumbing; appliances; flooring; art; and other miscellaneous home decor items and accessories. The revenue structure of the present invention at the B2B marketplace tier 3104 can range from a 2.5% to 15% commission of every sale facilitated through the marketplace and paid by the brand.

The base level of the revenue model 3100 is comprised of the SAAS operating system for creative users 3106. The creative users of the platform are comprised of: design professionals 3108; showrooms 3110; and brands 3112. Each of these different types of users pay a monthly subscription fee to use the platform SAAS operating system 3106. Design professionals 3108 have the lowest monthly subscription rate of the three types of creative users 3106, with a projected cost of $49 per month. Showrooms 3110 have a higher monthly subscription rate compared to design professionals 3108, with a projected cost of $199 per month. Brands 3112 have the highest monthly subscription rate compared to design professionals 3108 and showrooms 3110, with a projected cost of $399 per month.

The revenue model of the present invention can change and adapt over time. According to some embodiments, the current revenue model of the present invention is subscription based. This will prevent certain manufacturers to become advertising sponsors from purchasing advertisements on the platform that can distort marketplace results and workflow for designers. Designers are able to monetize the platform through project-based commissions.

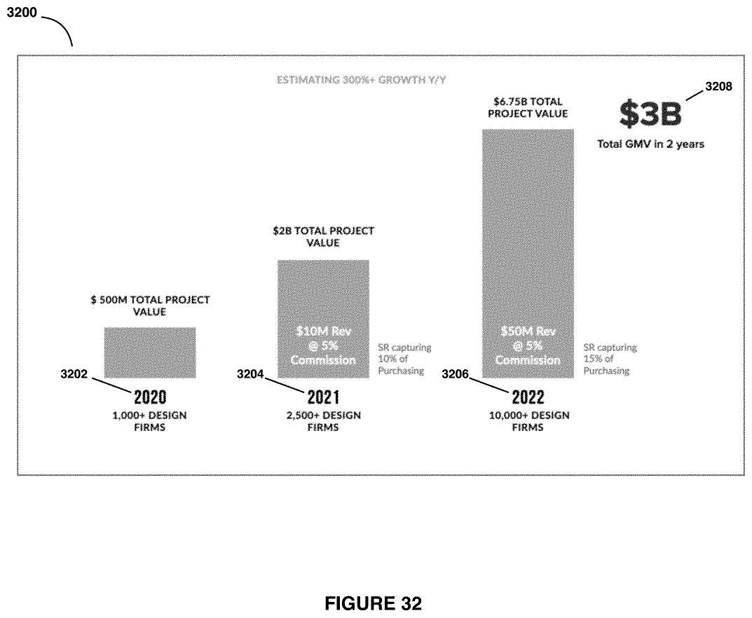

FIG. 32 is a diagram of projected annual revenue growth of the present invention. In accordance with present invention, projected annual revenue 3200 is based on unlocking early markets and product sales by design firms. Within the first year of launching the present invention 3202, the projected number of design firm users is approximately 1000 firms. This would generate an estimated $500 million in total project value. In the second year of platform operation 3204, the projected number of design firm users increases to 2500, generating an estimated $2 billion in total project value. Of the total project value at the end of the second year, the platform of the present invention is projected to earn a revenue of $10 million at a 5% commission rate, and 10% of all purchases facilitated through the platform. In the third year of platform operation 3206, the projected number of design firm users increases to 10,000, generating an estimated $6.75 billion in total project value. Of the total project value at the end of the third year, the platform of the present invention is projected to earn a revenue of $50 million at a 5% commission rate, and an increased rate of 15% of all purchases facilitated through the platform. Overall, this projected growth would result in $3 billion worth of Gross Merchandise Value (GMV) in 2 years 3208.

As more designers are adding more projects and products to the platform, the platform itself increases purchasing power. The present invention is able to determine what brands and products are not available through the platform, refining the present invention's brand acquisition strategy. As more brands and products are added to the marketplace of the platform of the present invention, this results in an increase of product coverage in designer projects and can facilitate connecting supply and demand in the platform marketplace to generate increased revenue.

While various embodiments of the disclosed technology have been described above, it should be understood that they have been presented by way of example only, and not of limitation. For example, the present invention may incorporate artificial intelligence and EDI tracking (and may also incorporate transportation tracking (with GPS location services and imaging) so that client satisfaction may be monitored and managed, and expectations met, and expectations maintained in a reasonable manner, taking into account past feedback and then adapting future expectations accordingly. Likewise, the various diagrams may depict an example architectural or other configuration for the disclosed technology, which is done to aid in understanding the features and functionality that may be included in the disclosed technology. The disclosed technology is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the technology disclosed herein. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

What is claimed is:

1. A system for collaborating design between designers, suppliers and clients comprising:
a processor providing browser accessible presentation of content, wherein said content comprises at least one image stream comprising a plurality of designer provided design elements, wherein said design elements include client spaces to be designed and designer specified actions to be taken to design said client spaces;
said processor arranging said content in designer curated collections;
said processor providing an interface between said client, said designer and said supplier, wherein said user may monitor and control said client space design including integrating supplier elements provided by said supplier purchased by said client;
said processor presenting an interface with said suppliers so that various design elements may be incorporated into said client space design;
wherein said client may optimize said client space design by comparing design options provided by said designer and availability of said design elements provided by said supplier to optimize said client space design.

2. The system of claim 1, wherein said design elements are each assigned a cost element so that said client may optimize said client space design based on cost.

3. The system of claim 1, wherein said design elements are each assigned a size element so that said client may optimize said client design space based on physical dimensions associated with said user space and physical dimensions associated with elements provided by said suppliers.

4. The system of claim 1, wherein said design elements are each assigned a lead time size element so that said client may optimize said client design space based on lead times associated with obtaining elements provided by said suppliers.

5. The system of claim 4, wherein said lead times include transportation time for said elements to be transported from an element vendor to said client space, and wherein said transportation time is obtained via a communication link with a transportation vendor.

6. The system of claim 5, wherein said transportation vendor is a common carrier.

7. The system of claim 6, wherein a client interface enables said client choices to optimize cost, dimensions and delivery schedules for maximum benefit to said client.

8. A method for collaborating design between designers, suppliers and clients comprising:
activating a processor providing browser accessible presentation of content, wherein said content comprises at least one image stream comprising a plurality of designer provided design elements, wherein said design elements include client spaces to be designed and designer specified actions to be taken to design said client spaces;
using said processor for arranging said content in designer curated collections;
using said processor for providing an interface between said client, said designer and said supplier, wherein said user may monitor and control said client space design including integrating supplier elements provided by said supplier purchased by said client;
using said processor for presenting an interface with said suppliers so that various design elements may be incorporated into said client space design;
wherein said client may optimize said client space design by comparing design options provided by said designer and availability of said design elements provided by said supplier to optimize said client space design.

9. The method of claim 8, wherein said design elements are each assigned a cost element so that said client may optimize said client space design based on cost.

10. The method of claim 8, wherein said design elements are each assigned a size element so that said client may optimize said client design space based on physical dimensions associated with said user space and physical dimensions associated with elements provided by said suppliers.

11. The method of claim 8, wherein said design elements are each assigned a lead time size element so that said client may optimize said client design space based on lead times associated with obtaining elements provided by said suppliers.

12. The method of claim 11, wherein said lead times include transportation time for said elements to be transported from an element vendor to said client space, and wherein said transportation time is obtained via a communication link with a transportation vendor.

13. The method of claim 12, wherein said transportation vendor is a common carrier.

14. The method of claim 13, wherein a client interface enables said client choices to optimize cost, dimensions and delivery schedules for maximum benefit to said client.

15. A system for collaborating design between designers, suppliers and clients comprising:
a processor providing browser accessible presentation of content, wherein said content comprises at least one image stream comprising a plurality of designer provided design elements, wherein said design elements include client spaces to be designed and designer specified actions to be taken to design said client spaces;
said processor arranging said content in designer curated collections;
said processor providing an interface between said client, said designer and said supplier, wherein said user may monitor and control said client space design including integrating supplier elements provided by said supplier purchased by said client;
said processor presenting an interface with said suppliers so that various design elements may be incorporated into said client space design;
said client may optimize said client space design by comparing design options provided by said designer and availability of said design elements provided by said supplier to optimize said client space design;
said design elements are each assigned a cost element so that said client may optimize said client space design based on cost;
said design elements are each assigned a size element so that said client may optimize said client design space based on physical dimensions associated with said user space and physical dimensions associated with elements provided by said suppliers wherein said design elements are each assigned a lead time size element so that said client may optimize said client design space based on lead times associated with obtaining elements provided by said suppliers.
